(19) United States
(12) Patent Application Publication
(10) Pub. No.: US 2017/0044404 A1
(43) Pub. Date: Feb. 16, 2017

(54) LAMINATE SHEET

(71) Applicant: NITTO DENKO CORPORATION, Ibaraki-shi, Osaka (JP)

(72) Inventors: Shuuhei YAMAMOTO, Ibaraki-shi, Osaka (JP); Hironori TAMAI, Ibaraki-shi, Osaka (JP); Kazumichi KATO, Ibaraki-shi, Osaka (JP)

(73) Assignee: NITTO DENKO CORPORATION, Ibaraki-shi, Osaka (JP)

(21) Appl. No.: 15/305,403

(22) PCT Filed: Apr. 22, 2015
(86) PCT No.: PCT/JP2015/062183

§ 371 Date: Oct. 20, 2016

(30) Foreign Application Priority Data
Apr. 24, 2014 (JP) 2014-090716
Nov. 20, 2014 (JP) 2014-235850

(51) Int. Cl. C09J 7/02; B32B 7/14; B32B 7/06; B32B 27/36; C09J 133/08; B32B 7/12

(52) U.S. Cl. CPC C09J 7/0217; C09J 7/0285; C09J 7/0289; C09J 133/08; B32B 7/12; B32B 7/06; B32B 27/36; B32B 7/14; C09J 2433/00

(57) ABSTRACT

Provided is a laminate sheet with which degradation of the appearance after its application can be highly prevented while maintaining good adhesive properties. The laminate sheet provided by this invention is a long laminate sheet having an adhesive surface. The laminate sheet comprises a PSA layer forming the adhesive surface and an air-impermeable substrate sheet supporting the PSA layer. The substrate sheet surface is partially provided with the PSA layer, whereby the substrate sheet surface has a PSA-bearing area and a PSA-free area. The PSA-free area includes at least a strip-shaped area. The strip-shaped area runs at angles intersecting the width-direction edges of the laminate sheet.

### TECHNICAL FIELD

The present invention relates to a laminate sheet. This application claims priority to Japanese Patent Application No. 2014-090716 filed on Apr. 24, 2014 and Japanese Patent Application No. 2014-235850 filed on Nov. 20, 2014; the entire contents thereof are incorporated herein by reference.

### BACKGROUND ART

Sheets having adhesiveness are widely used for purposes such as protecting surfaces of various objects or obtaining desirable appearances such as decoration. These sheets are also used, for example, as substitutes for paints. Since they have excellent handling properties, their applications are not limited to just paint substitutes, but are expanding. An example of literature disclosing this type of conventional art is Patent Document 1. Patent Documents 2 and 3 are technical literature related to air/vapor-permeable pressure-sensitive adhesive (PSA) tapes for medical applications.

### CITATION LIST

### Patent Literature

### [Patent Document 1] Japanese Translation of PCT International Application No. 2004-506777

[Patent Document 2] Japanese Patent Application Publication No. H10-328231

### [Patent Document 3] Japanese Patent No. 5371292

### SUMMARY OF INVENTION

### Technical Problem

When applied to adherends, conventional adhesive sheets sometimes degrade the appearance, leaving foreign fluids such as air and moisture between the sheets and the adherends (or in the “adhered areas” for convenience, hereinafter) which result in trapped air, trapped moisture, etc., looking like bubbles. Such trapped air and the like are undesired also in view of having an impact on the adhesive properties, such as causing a decrease in adhesive strength, etc. To avoid such situations, in a known technique (e.g. see Patent Document 1), on the surface of a release liner protecting the adhesive surface of an adhesive sheet, protruding ridges are formed, which are used to form grooves in the adhesive surface of the sheet, so that the air and the like tending to be left in the adhered area are released from these grooves. However, in the conventional art, the viscoelastic material forming the adhesive surface is depressed to form the grooves and thus, their depth is limited; depending on the thickness of the viscoelastic material layer, the method for forming the same, and so on, desirable air release properties may not be obtained. In addition, the ridges need to be formed in advance on the release liner surface, making it disadvantageous in productivity as well. Moreover, depending on where the sheet is cut off, etc., a groove in the adhesive surface may run in parallel with an edge of the PSA sheet near the edge, thereby leading to the occurrence of events such as decreased adhesiveness near the edge (e.g. edge peel, etc.). Patent Documents 2 and 3 relate to medical PSA tapes having air permeability in the thickness direction. They are silent about maintaining their appearance and adhesive strength.

The present invention has been made in view of the circumstances described above with an objective to provide a laminate sheet with which degradation of the appearance after its application can be highly prevented while maintaining good adhesive properties.

### Solution to Problem

This invention provides a long piece of laminate sheet having an adhesive surface. The laminate sheet comprises a PSA layer forming the adhesive surface and an air-impermeable substrate sheet supporting the PSA layer. Bearing the PSA layer partially in an area, the surface of the substrate sheet has a PSA-bearing area and a PSA free area. The PSA-free area includes at least an area in a band (or simply a band or a strip-shaped area, hereinafter). The band runs at angles that intersect the width direction edges (ends in the width direction, i.e. lengthwise edges) of the laminate sheet.

In this embodiment, a groove (dented line) is formed in the area corresponding to the PSA-free band in the adhesive surface. Via this groove, foreign fluids such as air and moisture looking to remain in an area adhered to the adherend surface are eliminated from the adhered area, whereby the occurrence of trapped air and the like in the adhered area is prevented. The depth of the groove in the adhesive surface is generally equal to the thickness of the PSA layer; and therefore, the cross-sectional area of the groove can be designed larger than allowed by the method where the PSA layer surface is depressed. Accordingly, it highly prevents degradation of the appearance and impacts on the adhesive properties caused by the air and the like remaining in the adhered area. For instance, even when, for reasons such as that at least a certain level of adhesive strength is required, it is limited in increasing the groove width and the number of grooves, air release properties and adhesive strength can be still combined.

Typically, when trying to obtain properties to release air and the like in the adhesive surface of a PSA sheet, the first thought is to have air permeability in the thickness direction. However, in applications that require designs, protection, light-blocking properties, etc., it may not be a realistic choice because of impacts on these properties. The art disclosed herein allows release of air and the like in directions in the plane of the laminate sheet. Thus, for instance, even in an embodiment as described above (typically an embodiment using an air-impermeable substrate), good air release properties can be obtained.

The strip-shaped area of the PSA-free area (or simply PSA-free band, hereinafter) runs at angles that intersect the width-direction edges of the laminate sheet. This prevents the occurrence of situations, such as lowered adhesiveness near a width direction edge (e.g. edge peel, etc.), caused by the band running in parallel with the edge of the laminate sheet in the vicinity of the edge.

In a preferable embodiment of the laminate sheet disclosed herein, the PSA bearing area includes two or more areas separately placed in the surface of the substrate sheet. The PSA-free band is located between two adjacent areas among the two or more areas of the PSA-bearing area Like this, by separately placing the areas of the PSA-bearing area, a groove that serves as channels for air and the like can be efficiently formed in the adhesive surface. By separately placing the areas of the PSA-bearing area, two or more PSA sections are separately arranged thereon. This increases the conformability to an adherend surface having a curved face (typically a three-dimensionally curved face).

In a preferable embodiment of the laminate sheet disclosed herein, in the surface of the substrate sheet, the PSA-bearing area includes two or more bands and so does the PSA-free area. The bands of the PSA-bearing area and the bands of the PSA-free area are alternately arranged. In this embodiment, two or more grooves are formed in the adhesive surface, enhancing the contact between the grooves and air or the like looking to be left in the adhered area. With the bands of PSA where the PSA is present and the grooves lacking the PSA alternately placed, the PSA layer has a stripe pattern, whereby desirable air release properties can be obtained while giving observers the impression that the appearance is kept under control. This brings about an effect to resolve or reduce the feeling of strangeness associated with the external change resulted from the groove formation; it is practically significant in view that the spectrum of application of the laminate sheet can be expanded.

In a preferable embodiment of the laminate sheet disclosed herein, the band(s) (at least one band, preferably two or more bands) of the PSA-free area follows winding courses over the surface of the substrate sheet. In the embodiment where the bands follow winding courses over the adhesive surface, the contact with air and the like looking to remain in the adhered area will be enhanced.

In a preferable embodiment of the laminate sheet disclosed herein, the band(s) (at least one band, preferably two or more bands) of the PSA-free area follows regularly-winding courses (courses with regularly repeating curves) over the surface of the substrate sheet. With such a regularly repeating configuration, the contact with air and the like looking to remain in the adhered area will be enhanced as compared to linear or arc configurations. With the regularly repeating arrangement, desirable air release properties can be obtained while giving observers the impression that the appearance is kept under control in the pattern.

In a preferable embodiment of the laminate sheet disclosed herein, the band(s) (at least one band, preferably two or more bands) of the PSA-free area runs in curves on the surface of the substrate sheet. This embodiment allows smoother application to adherends, thereby increasing the ease of application. An arrangement that may cause edge peel near the edges of the laminate sheet can be more certainly avoided.

In a preferable embodiment of the laminate sheet disclosed herein, the substrate sheet comprises a resin sheet layer. With the substrate sheet comprising the resin sheet layer, the laminate sheet has suitable rigidity and tends to provide great ease of application to adherends. The inclusion of the resin sheet layer is also advantageous in making it thinner, enhancing the appearance, and so on. The ease of application encompasses not only the ease of work for application, but also the ease of obtaining a good state of adhesion. For instance, that the area adhered to the adherend is essentially free of air and the like is indicative of great ease of application in view of reducing the amount of load such as reapplication work and obtaining secure adhesion.

In a preferable embodiment of the laminate sheet disclosed herein, the substrate sheet has a thickness of 100 μm or smaller. When the thickness of the substrate sheet is limited as described above, the laminate sheet can be favorably obtained thinner, smaller, lighter, resource-saving, and so on. Even when a thin substrate as described above is used, the occurrence of trapped air and the like can be favorably prevented to bring about great workability for application.

In a preferable embodiment of the laminate sheet disclosed herein, the adhesive surface shows a 180° peel strength of 2 N/20 mm or greater. According to the art disclosed herein, even with the PSA-free area, such peel strength can be obtained.

This invention also provides a release liner-supported laminate sheet, with the sheet comprising a laminate sheet disclosed herein and a release liner protecting the adhesive surface of the laminate sheet. The adhesive surface-side surface of the release liner is formed smooth. According to the art disclosed herein, a groove that allows air and the like to pass through can be formed in the adhesive surface of the laminate sheet without subjecting the release liner surface to a process such as embossing, making it advantageous for practical use.

### BRIEF DESCRIPTION OF DRAWINGS

FIG. 1 shows a top view schematically illustrating an embodiment of the laminate sheet.

FIG. 2 shows a cross-sectional view at line II-II in FIG. 1.

### DESCRIPTION OF EMBODIMENTS

Preferred embodiments of the present invention are described below. Matters necessary to practice this invention other than those specifically referred to in this description may be understood as design matters based on the conventional art in the pertinent field for a person of ordinary skill in the art. The present invention can be practiced based on the contents disclosed in this description and common technical knowledge in the subject field. In the drawings referenced below, a common reference numeral may be assigned to members or sites producing the same effects, and duplicated descriptions are sometimes omitted or simplified. The embodiments described in the drawings are schematized for clear illustration of the present invention, and do not necessarily represent the accurate sizes or reduction scales of the laminate sheet of the present invention provided as an actual product.

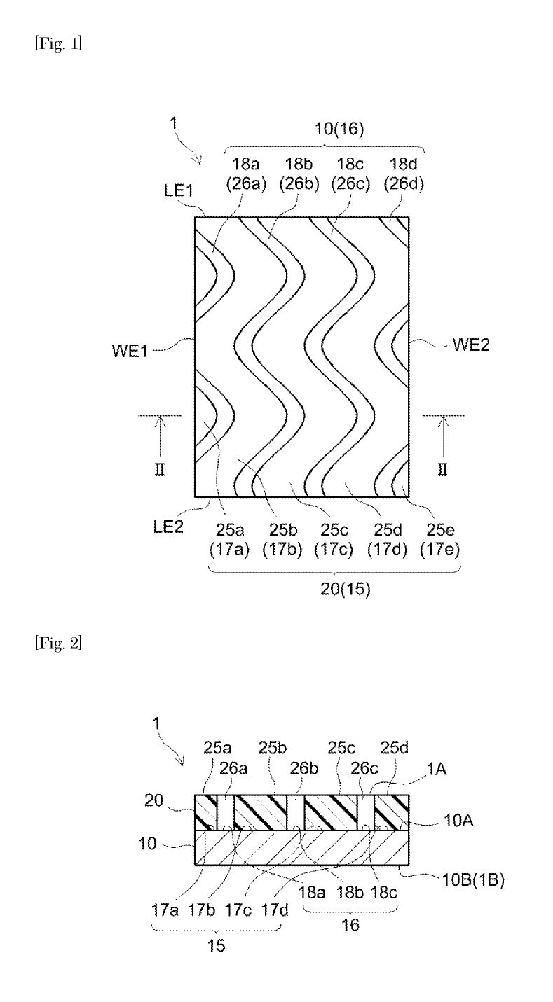

FIG. 1 shows a top view schematically illustrating an embodiment of the laminate sheet. FIG. 2 shows a cross-sectional view at line II-II in FIG. 1. With reference to the drawings, the laminate sheet in this embodiment is described.

As shown in FIGS. 1 and 2, laminate sheet 1 according to this embodiment has a laminate structure with an air-impermeable substrate sheet 10 and a PSA layer 20. Substrate sheet 10 supports PSA layer 20. In laminate sheet 1, the surface on the PSA layer 20 side forms an adhesive surface 1A. The other surface 1B (on the substrate sheet 10 side) of laminate sheet 1 is a non-adhesive surface. Laminate sheet 1 is a long piece of sheet. In this embodiment, the longitudinal direction in FIG. 1 corresponds to the length direction of laminate sheet 1.

PSA layer 20 is placed partially over the surface 10A of substrate sheet 10. By this, the surface 10A of substrate sheet 10 has PSA-bearing area 15 over which PSA layer 20 is placed and PSA-free area 16 where PSA layer 20 is absent.

The PSA-free area 16 is formed with bands 18a, 18b, 18c and 18d continuously running in the length direction. These bands 18a, 18b, 18c and 18d are placed at constant intervals in the width direction of laminate sheet 1, with each being bound by the PSA-bearing area 15. This makes the PSA-free area 16 to form a stripe pattern at large over the substrate sheet surface 10A. In this embodiment, bands 18a, 18b 18c and 18d all run through the edges of laminate sheet 1.

Bands 18a, 18b, 18c and 18d of the PSA-free area 16 run at angles that intersect the width-direction edges WE1 and WE2 of laminate sheet 1. In particular, they run in wavy shapes. Accordingly, among bands 18a, 18b, 18c and 18d of the PSA-free area 16, the band 18a next to the width-direction edge WE1 of laminate sheet 1 reaches the edge WE1 at an angle that intersects the edge WE1. Similarly, the band 18d next to the width direction edge WE2 of laminate sheet 1 reaches the edge WE2 at an angle that intersects the edge WE2. With respect to length-direction edges LE1 and LE2 of laminate sheet 1, bands 18a, 18b, 18c and 18d of PSA-free area 16 run at angles that intersect the edges LE1 and LE2 to reach the edges LE1 and LE2.

The PSA-bearing area 15 is also formed with bands 17a, 17b, 17c, 17d and 17e. These bands 17a to 17e are placed at constant intervals in the width direction of laminate sheet 1. A band (e.g. 18b) of PSA-free area 16 is placed between two adjacent bands (e.g. 17b and 17c) among the bands 17a to 17e of the PSA-bearing area 15. In the substrate sheet surface 10A, bands 17a, 17b, 17c, 17d and 17e of PSA-bearing area 15 and bands 18a, 18b, 18c and 18d of PSA-free area 16 are alternately arranged. Accordingly, bands 17a, 17b, 17c, 17d and 17e of PSA-bearing area 15 also run in continuous wavy shapes in the length direction, corresponding to the shapes of bands 18a, 18b, 18c and 18d of PSA-free area 16. On the substrate sheet surface 10A, a wavy stripe pattern (a curvilinear pattern) is formed by the combination of the PSA-bearing area 15 and the PSA-free area 16.

Relative to the adhesive surface 1A, the configuration above can be described as follows. The PSA layer 20 is formed of several PSA sections 25a, 25b, 25c, 25d and 25e. These PSA sections 25a to 25e are placed over the bands 17a to 17e of PSA-bearing area 15 in the substrate sheet surface 10A, respectively. Accordingly, PSA sections 25a to 25e have the same shapes and pattern (specifically, the wavy shapes in a stripe pattern) as the bands 17a to 17e of PSA-bearing area 15 in the substrate sheet surface 10A.

Over the bands 18a, 18b, 18c and 18d of PSA-free area 16 in the substrate sheet surface 10A, grooves 26a, 26b, 26c and 26d are formed, with each being bound by two adjacent sections among the several PSA sections 25a to 25e. Accordingly, grooves 26a, 26b, 26c and 26d have the same shapes and pattern (specifically, the wavy shapes in a stripe pattern) as the bands 18a, 18b, 18c and 18d of PSA-free area 16 in the substrate sheet surface 10A. Bands 18a, 18b, 18c and 18d form the bottoms of grooves 26a, 26b, 26c and 26d, respectively; and therefore, the bottoms of grooves 26a, 26b, 26c and 26d are flat. In this embodiment, the cross sections of grooves 26a, 26b, 26c and 26d (cross sections that vertically intersect the running direction of the grooves) are U shaped (or rectangular) with top openings, but they are not limited to this and can be trapezoidal and so on.

As described above, the PSA layer 20 in the adhesive surface 1A corresponds to the substrate sheet surface 10A to have a wavy stripe pattern by the combination of an area where PSA is present (PSA sections 25a to 25e) and an area where PSA is absent (grooves 26a, 26b, 26c and 26d).

The widths of the respective bands 18a, 18b, 18c and 18d (grooves 26a, 26b, 26c and 26d) of PSA-free area 16 can be selected so as to obtain desirable air release properties and adhesive strength and are not particularly limited; they are suitably within a range of about 0.1 mm to 5 mm (preferably 0.3 mm to 3 mm or more preferably 0.5 mm to 2 mm) The groove widths refer to the shortest widths of the grooves at the PSA layer surface.

The widths of PSA sections 25a to 25e (which may also be the widths of the respective bands 17a to 17e) can be selected so as to obtain desirable air release properties and adhesive strength and are not particularly limited; they are suitably within a range of 1 mm to 100 mm (preferably 2 mm to 50 mm, e g 3 mm to 30 mm) The widths are the intervals between grooves (distances of the spaces between two adjacent grooves in the PSA layer surface) and refer to the shortest widths of the PSA sections in the PSA layer surface.

When the respective bands 18a, 18b, 18c and 18d (grooves 26a, 26b, 26c and 26d) of PSA-free area 16 follow winding courses with regularly repeating curves (typically having wavy shapes), from the standpoint of the air release properties, etc., their amplitude (swinging widths) is suitably within a range of 5 mm to 200 mm (preferably 10 mm to 150 mm or more preferably 40 mm to 100 mm) With respect to a single groove (a PSA-free area) in the pattern, the amplitude refers to the difference in height between a mountain and a valley (i.e. the wave height) in the wave pattern formed with the groove, with the difference being in the direction that vertically intersects the direction in which the groove runs (typically the length direction of laminate sheet 1).

When the respective bands 18a, 18b, 18c and 18d (grooves 26a, 26b, 26c and 26d) of PSA-free area 16 follow winding courses with regularly repeating curves (typically having wavy shapes), for each of bands 18a, 18b, 18c and 18d (grooves 26a, 26b, 26c and 26d), the repeating pitch (or simply the “pitch” hereinafter) can be selected so as to obtain desirable air release properties and adhesive strength and is not particularly limited; it is suitably within a range of 10 mm to 500 mm (preferably 30 mm to 300 mm or more preferably 60 mm to 200 mm) The repeating pitch is typically the wave length which refers to the distance in the running direction of a wave from one peak to its adjacent peak (the distance in the direction (horizontal direction) orthogonal to the vertical direction of the wave).

Prior to use, laminate sheet 1 may have a configuration where the other surface 10B (opposite from the PSA layer 20-side surface 10A) is a release face and laminate sheet 1 is wound so that the other surface 10B is in contact with the PSA layer 20, whereby the adhesive surface 1A is protected with the other surface 10B of substrate sheet 10. Alternatively, it may be a release liner-supported laminate sheet having a configuration where the PSA layer 20 is protected with a release liner (not shown in the drawings) having a release face at least on the adhesive surface 1A side.

As in the embodiment described above, the art disclosed herein can be preferably implemented in an embodiment where the bands of the PSA-free area follow winding courses with regularly repeating curves (typically in wavy shapes) on the surface of the substrate sheet, with two or more bands forming a wavy stripe pattern. The shapes and pattern favorably prevent the occurrence of edge peel and the like near the laminate sheet edges to obtain smooth, even application. Examples of the wavy shapes include curves such as sine waves, quasi-sine waves, arc waves and the like as well as non-curves such as zigzag shapes, triangular waves and the like. The wavy pattern may be formed of two or more waves having the same or different shapes, layered with a phase difference or with the shapes or pattern inverted, and so on. The bands of PSA-free area may be, for instance, arc-shaped, circular, oval or linear. When it is linear, it may extend in a direction that intersects (e.g. vertically or diagonally) the length direction of the laminate sheet.

The substrate sheet used in the art disclosed herein is characterized by being impermeable to air. In a laminate sheet comprising an air-impermeable substrate sheet, it is basically difficult to release air and the like in the thickness direction. In an embodiment comprising such an air-impermeable substrate, the art disclosed herein can highly prevent the occurrence of trapped air and the like in the adhered area. In this description, being “air-impermeable” means that the air permeability determined from the time required for 100 mL of air to pass through it exceeds 30 seconds (/100 mL). The air permeability is measured based on the Gurley test method specified in JIS P 8117:1998. The substrate sheet preferably has an air permeability of 70 sec/100 mL or higher (e.g. 100 sec/100 mL or higher).

In addition to being air-impermeable, from the standpoint of the ease of application, etc., the substrate sheet disclosed herein may exhibit low elongation properties. In particular, the substrate sheet may have an elongation at break of less than 1000% when measured based on JIS K 6767:1999. The elongation at break of the substrate sheet may be less than 700% (e.g. less than 500%, typically less than 200 V.

As the substrate sheet, for instance, a resin sheet, paper, cloth, a rubber sheet, a foam sheet, metal foil, a composite or laminate of these, and the like can be used. Among them, from the standpoint of the ease of application and the quality of the sheet appearance (e.g. the attractiveness of the outer surface of the sheet), it preferably comprises a resin sheet layer. The inclusion of the resin sheet is advantageous also from the standpoint of the dimensional stability, thickness precision, workability, peel strength, and so on. Preferable examples of the resin sheet include a polyolefinic resin sheet such as of polyethylene and polypropylene; a polyester-based resin sheet such as of polyethylene terephthalate (PET) and polybutylene terephthalate. Among resin sheets, polyester sheets are more preferable and PET sheets are particularly preferable among them. The substrate sheet may have a mono-layer structure or a multi-layer structure with two, three or more layers.

In a preferable embodiment, the substrate sheet is a substrate comprising a foam sheet (a foam-containing substrate). This provides impact-absorbing capabilities to the laminate sheet. Here, the foam sheet refers to a sheet structure having a part with foam cells (a foam cell structure). The foam-containing substrate may be a mono-layer structure formed from a foam sheet or a multi-layer structure wherein at least one of whose two or more layers is formed of a foam sheet (a foam layer). A configurational example of the foam-containing substrate is a composite substrate in which a foam sheet (a foam layer) and a non-foamed sheet (a non-foamed layer) are laminated. The non-foamed sheet (non-foamed layer) refers to a sheet structure that has not been subjected to a purposeful foaming process (e.g. a process to incorporate foam cells), referring to a sheet essentially free of a foam cell structure. A typical example of the foam sheet is a resin sheet (e.g. a polyester-based resin sheet such as of PET) having an expansion rate of less than 1.1-fold (e.g. less than 1.05-fold, typically less than 1.01-fold). When the substrate sheet comprises two or more foam layers, the materials and structures of these foam layers can be identical or different. When the foam sheet has a multi-layer structure that includes a foam layer, from the standpoint of increasing the tightness between layers, adhesive layers may be placed between the layers.

The foam sheet is not particularly limited in average foam cell diameter; it is usually suitably 10 μm to 200 μm, preferably 20 μm to 180 μm, or more preferably 30 μm to 150 μm. When the average foam cell diameter is 10 μm or larger, the impact-absorbing properties tend to increase. On the other hand, when the average foam cell diameter is 200 μm or smaller, the handling properties and waterproof properties (water-blocking properties) tend to increase. The average foam cell diameter is measured by the method described later in Examples.

The foam sheet is not particularly limited in density (apparent density); it is usually suitably 0.01 g/cm³ or higher, preferably 0.01 g/cm³ to 0.7 g/cm³, or more preferably 0.02 g/cm³ to 0.5 g/cm³. When the density is 0.01 g/cm³ or higher, the strength of the foam sheet (and even that of the laminate sheet) will increase with a tendency toward greater impact resistance and handling properties. On the other hand, when the density is 0.7 g/cm³ or lower, the conformability to a difference in level tends to increase without an excessive decrease in flexibility. The density of the foam sheet is measured by the method described later in Examples.

The 50% compressive stress of the foam sheet is not particularly limited. From the standpoint of the impact resistance, the foam sheet suitably shows a 50% compressive stress of 0.1 N/cm² or greater. When the 50% compressive stress is at or above a certain value, for instance, even if the foam sheet is thin (e g about 100 μm thick), it can show sufficient resistance when compressed (resilience to compression) and maintain good impact resistance. The 50% compressive stress is preferably 0.2 N/cm² or greater, or more preferably 0.5 N/cm² or greater. From the standpoint of combining flexibility and impact resistance in a well-balanced way, the 50% compressive stress is suitably 8 N/cm² or less, preferably 6 N/cm² or less, more preferably 3 N/cm² or less, or yet more preferably 2 N/cm² or less. The 50% compressive stress is measured based on JIS K 6767:1999. More specifically, it is measured by the method described later in Examples.

The foam constituting the foam sheet disclosed herein is not particularly limited in foam cell structure. The foam cell structure can be a continuous foam cell structure, an isolated foam cell structure, or a semi-continuous foam cell structure. From the standpoint of the impact absorbing properties, continuous and semi-continuous foam cell structures are preferable.

The material of the foam sheet is not particularly limited. The foam sheet can be typically formed from a material comprising a polymer component (e.g. a thermoplastic polymer). A preferable foam sheet is usually formed of foam of a plastic material (plastic foam). The plastic material (which means to include a rubber material) for forming the plastic foam is not particularly limited; a suitable species can be selected among known plastic materials. For the plastic material (typically a thermoplastic polymer), solely one species or a combination of two or more species can be used. The primary component (typically a component accounting for more than 50% by weight) among the polymers in the substrate sheet or the foam sheet may be referred to as the “base polymer” hereinafter.

Specific examples of the foam include polyolefinic resin foam such as polyethylene foam and polypropylene foam; polyester-based foam such as polyethylene terephthalate foam, polyethylene naphthalate foam and polybutylene terephthalate foam; polyvinyl chloride-based resin foam such as polyvinyl chloride foam; vinyl acetate-based foam; acrylic resin foam; polyphenylene sulfide resin foam; amide-based resin foam such as polyamide (nylon) resin foam and all-aromatic polyamide (aramide) resin foam; polyimide-based resin foam; polyether ether ketone (PEEK) foam; styrene-based resin foam such as polystyrene foam; and urethane-based resin foam such as polyurethane resin foam. As the foam, rubber-based resin foam such as polychloroprene rubber foam can be used as well.

In a preferable embodiment, acrylic resin foam is used as the foam. Here, the acrylic resin foam refers to foam comprising an acrylic polymer as the base polymer. The acrylic polymer in this description is as defined later. As the alkyl (meth)acrylate forming the acrylic polymer, one, two or more species can be preferably used among alkyl (meth)acrylates having acyclic alkyl groups with 1 to 20 (preferably 1 to 8, typically 1 to 4) carbon atoms. Preferable examples of the alkyl (meth)acrylate include ethyl acrylate, n-butyl acrylate and 2-ethylhexyl acrylate. The amount of the alkyl (meth)acrylate as the primary monomer is suitably 70% by weight or more of all monomers in the acrylic polymer, or preferably 75% by weight or more (e.g. 80% by weight or more). The amount of the alkyl (meth)acrylate is suitably 98% by weight or less of all the monomers, or preferably 97% by weight or less (e.g. 96% by weight or less).

The secondary monomer co-polymerizable with the alkyl (meth)acrylate as the primary monomer may be useful in introducing crosslinking points in the acrylic polymer or in increasing the cohesive strength of the acrylic polymer. As the secondary monomer, one, two or more species of functional group-containing monomers can be used among, for instance, carboxy group-containing monomers, hydroxy group-containing monomers, acid anhydride group-containing monomers, amide group-containing monomers, amino group-containing monomers, cyano group-containing monomers, monomers having nitrogen atom-containing rings and the like. The secondary monomer can also be a vinyl ester-based monomer such as vinyl acetate, an aromatic vinyl compound such as styrene, a sulfonate group-containing monomer, a phosphate group-containing monomer and the like. The amount of the secondary monomer is suitably 0.5% by weight or more of all monomers in the acrylic polymer, or preferably 1% by weight or more. The amount of the secondary monomer is suitably 30% by weight or less of all the monomers, or preferably 10% by weight or less.

When the foam is formed with an emulsion-based resin composition by a foaming method where gases including air are mixed in mechanically such as by stirring, it is preferable that the monomers forming the acrylic polymer comprise a nitrogen atom-containing monomer as the secondary monomer. This facilitates the formation of foam cells in the foaming process and may increase the viscosity of the composition when forming the foam (typically when drying the resin composition), whereby the foam cells are readily kept in the foam body.

Examples of the nitrogen atom-containing monomer include cyano group-containing monomers such as acrylonitrile and methacrylonitrile; lactam ring-containing monomers such as N-vinyl-2-pyrolidone; amide group-containing monomers such as (meth)acrylamide, N-hydroxyethyl(meth)acrylamide, N-methylolacrylamide, N,N-dimethylacrylamide, N,N-diethylacrylamide and diacetone acrylamide. These can be used solely as one species or in a combination of two or more species. Among them, cyano group-containing monomers such as acrylonitrile and lactam ring-containing monomers such as N-vinyl-2-pyrolidone are preferable.

The amount of the nitrogen atom-containing monomer is suitably 2% by weight or more of all monomers in the acrylic polymer, or preferably 3% by weight or more (e.g. 4% by weight or more). The amount of the nitrogen atom-containing monomer is suitably 30% by weight or less of all the monomers, or preferably 25% by weight or less (e.g. 20% by weight or less).

The method for obtaining the acrylic polymer is not particularly limited. Various polymerization methods known as procedures for the synthesis of acrylic polymer can be suitably used, such as solution polymerization, emulsion polymerization, bulk polymerization, suspension polymerization, active energy ray polymerization (e.g. UV polymerization). For instance, a desirable acrylic polymer can be obtained by dissolving or dispersing a monomer mixture in a suitable polymerization solvent (toluene, ethyl acetate, water, etc.) and carrying out polymerization using a polymerization initiator such as an azo-based polymerization initiator and a peroxide-based initiator. In view of the ease of foaming and environmental aspects, it is preferable to use acrylic resin foam (emulsion-based acrylic resin foam) obtained by emulsion polymerization.

From the standpoint of increasing the cohesive strength, the acrylic resin foam-forming composition preferably comprises a crosslinking agent. The type of crosslinking agent is not particularly limited. Among various crosslinking agents, one, two or more species can be suitably selected and used. Favorable examples of the crosslinking agent include isocyanate-based crosslinking agents, epoxy-based crosslinking agents, oxazoline-based crosslinking agents, carbodiimide-based crosslinking agents, melamine-based crosslinking agents and metal oxide-based crosslinking agents. In particular, oxazoline-based crosslinking agents are preferable. The amount of the crosslinking agent used is not particularly limited. To 100 parts by weight of the acrylic polymer, it is suitably selected from a range of about 10 parts by weight or less (e.g. about 0.005 part to 10 parts by weight, preferably about 0.01 part to 5 parts by weight).

In another preferable embodiment, polyolefinic resin foam is used as the foam. As the plastic material forming the polyolefinic foam, various known or commonly-used polyolefinic resins can be used without particular limitations. Examples include polyethylene such as low density polyethylene (LDPE), linear low density polyethylene (LLDPE), high density polyethylene (HDPE) and metallocene catalyst-based linear low density polyethylene; polypropylene; ethylene-propylene copolymer; and ethylene-vinyl acetate copolymer. Among these polyolefinic resins, solely one species or a combination of two or more species can be used.

From the standpoint of the impact resistance, waterproof properties, etc., favorable examples of the foam sheet in the art disclosed herein include a polyethylene-based foam sheet essentially formed of polyethylene-based resin foam and a polypropylene-based foam sheet essentially formed of polypropylene-based resin foam. Here, the polyethylene-based resin refers to resin formed from ethylene as the primary monomer (i.e. the primary component among the monomers) and may include HDPE, LDPE and LLDPE as well as ethylene-propylene and ethylene-vinyl acetate copolymers of which ethylene is copolymerized at a ratio above 50% by weight. Similarly, the polypropylene-based resin refers to resin formed from propylene as the primary monomer. As the foam sheet in the art disclosed herein, a polypropylene-based foam sheet can be preferably used.

The foaming method for the foam sheet is not particularly limited. In accordance with the purpose, ease of procedures, etc., chemical procedures, physical procedures and so on can be employed individually or in combination. From the standpoint of the contamination, etc., physical foaming methods are preferable. Specific examples include a foaming method where a sheet-forming material is prepared to contain a foaming agent such as a low boiling compound (e.g. a hydrocarbon) and thermally expandable microspheres and foam cells are formed from the foaming agent, a foaming method where gases such as air are mechanically mixed in, a foaming method by solvent removal which takes advantage of removal of a solvent such as water, and a foaming method using a supercritical fluid. For instance, a method where an inert gas (e.g. oxygen carbon dioxide) is injected into the foam sheet-forming polymer under increased pressure and the resultant is placed under reduced pressure to form a foam sheet. By this method, the average foam cell diameter can be easily controlled to be at or below a certain value and the foam sheet can be easily made to have a lower density.

The foam sheet is fabricated by employing a foaming method as described above. The formation of the foam sheet is not particularly limited. For instance, when employing a foaming method that mechanically admixes gases such as air, a resin composition (e.g. an emulsion-based resin composition) containing foam can be subsequently applied over a substrate or release paper, etc., and allowed to dry to obtain a foam sheet. From the standpoint of the foam stability, etc., the drying preferably includes a preliminary drying step at or above 50° C., but below 125° C. as well as a main drying step at 125° C. to 200° C. Alternatively, foam can be formed continuously into a sheet using a calendar, extruder, conveyer belt casting and so forth; or a method where a kneaded mixture of foam-forming materials is foamed and molded in a batch process can be employed. In forming the foam sheet, a surface layer may be removed by slicing to adjust the sheet to obtain desirable thickness and foam characteristics.

The thermoplastic polymer (e.g. a polyolefinic polymer) that can be included in the foam sheet may comprise a thermoplastic elastomer that exhibits properties of rubber at room temperature, but shows thermoplasticity at a high temperature. From the standpoint of the flexibility and conformability, one, two or more species can be used among thermoplastic elastomers, for instance, olefinic elastomers such as ethylene-propylene copolymer, ethylene-propylene-diene copolymer, ethylene-vinyl acetate copolymer, polybutene, polyisobutylene, and chlorinated polyethylene; styrene-based elastomers such as styrene-butadiene-styrene copolymer; thermoplastic polyester-based elastomers; thermoplastic polyurethane-based elastomers; and thermoplastic acrylic elastomers. Among them, a thermoplastic elastomer having a glass transition temperature of room temperature or lower (e.g. 20° C. or lower). The thermoplastic elastomer content in the foam sheet is preferably about 10% to 90% by weight (e.g. 20% to 80% by weight) of the thermoplastic polymer in the foam sheet.

From the standpoint of the ease of mixing a foam-forming gas and the foam stability, as the foaming agent, various surfactants can be used in the foam sheet-forming material (e.g. an emulsion-based acrylic resin composition), with examples including anionic surfactants, cationic surfactants, nonionic surfactants and amphoteric surfactants. Hydrocarbon-based and fluorine-based surfactants can be used as well. In particular, from the standpoint of reducing the foam cell diameters and stabilizing the foam, anionic surfactants are preferable; ammonium salts of fatty acids (typically ammonium salts of higher fatty acids) such as ammonium stearate are more preferable. For the surfactant, solely one species or a combination of two or more species can be used. The surfactant content is preferably about 0.1 part to 10 parts by weight (e.g. 0.5 part to 8 parts by weight) to 100 parts by weight of the base polymer of the foam sheet. The foaming agent in this description includes not only an agent that shows foaming capabilities, but also a foam cell diameter-adjusting agent to reduce the foam diameters as well as a foam stabilizer such as a foam-adjusting agent.

When the foam sheet-forming material is an aqueous dispersion (e.g. an acrylic emulsion), it is preferable to use a silicone-based compound as the foaming agent. By this, the recovery of thickness (the degree and speed of recovery) after compression tends to improve. A preferable silicone-based compound has 2000 or fewer siloxane bonds. Examples of the silicone-based compound include silicone oil, modified silicone oil, and silicone resin. In particular, dimethyl silicone oil and methyl phenyl silicone oil are preferable. As the silicone-based compound, a silicone-modified polymer (e.g. a silicone-modified acrylic polymer, a silicone-modified urethane-based polymer, etc.) can be used as well. These can be used solely as one species or in a combination of two or more species. The silicone compound content is preferably about 0.01 part to 5 parts by weight (e.g. 0.05 part to 4 parts by weight, typically 0.1 part to 3 parts by weight) to 100 parts by weight of the base polymer of the foam sheet.

From the standpoint of stabilizing the foam and increasing the ease of sheet formation, the foam sheet-forming material (e.g. an emulsion-based acrylic resin composition) may comprise a thickener. The thickener is not particularly limited. Examples include acrylic acid-based thickeners, urethane-based thickeners and polyvinyl alcohol-based thickeners. In particular, polyacrylic acid-based thickeners and urethane-based thickeners are preferable. The thickener content is preferably about 0.1 part to 10 parts by weight (e.g. 0.1 part to 5 parts by weight) to 100 parts by weight of the base polymer of the foam sheet.

When a foam-containing substrate is used as the substrate sheet, the foam sheet preferably comprises a foam-nucleating agent such as a metal hydroxide (e.g. magnesium hydroxide). This tends to facilitate the adjustment of the average foam cell diameter in the foam sheet to obtain desirable impact-absorbing properties, flexibility and so on. The foam-nucleating agent can be a metal oxide, composite oxide, metal carbonate, metal sulfate, etc. The foam-nucleating agent content is preferably about 0.5 part to 125 parts by weight (e.g. 1 part to 120 parts by weight) to 100 parts by weight of the base polymer of the foam sheet.

When using a foam-containing substrate as the substrate sheet, from the standpoint of inhibiting the foam from degassing while foam cells are being formed, the foam sheet preferably comprises a degassing inhibitor such as fatty acid amides. A more preferable fatty acid amide has a bis-amide structure. The degassing inhibitor can be a metal salt of a fatty acid as well. The degassing inhibitor content is preferably about 0.5 part to 10 parts by weight (e.g. 0.7 part to 8 parts by weight, typically 1 part to 6 parts by weight) to 100 parts by weight of the base polymer of the foam sheet.

The substrate sheet (e.g. a foam sheet) may comprise a softener so as to provide desirable fluidity to the sheet-forming material thereby to improve properties such as flexibility. With the inclusion of a softener in the foam sheet, properties such as ease of stretching the sheet and expansion ratio can be preferably adjusted. For example, one, two or more species can be preferably used among hydrocarbon-based softeners such as liquid paraffin, paraffin wax, micro wax and polyethylene wax; ester-based softeners such as glyceryl stearate; and fatty acid-based softeners. The softener content is preferably 0.5 part to 50 parts by weight (e.g. 0.8 part to 40 parts by weight, typically 1 part to 30 parts by weight) to 100 parts by weight of the base polymer of the substrate sheet (e.g. a foam sheet).

When emulsion-based acrylic resin foam is used, an arbitrary anticorrosive may be included to prevent corrosion of metal parts adjacent to the foam sheet. As the anticorrosive, an azole ring-containing compound is preferable. With the use of an azole ring-containing compound, inhibition of metal corrosion and tight adhesion to adherends can be combined at a high level. In particular, a compound with the azole ring forming a fused ring with an aromatic ring such as a benzene ring is preferable; benzotriazole-based compounds and benzothiazole-based compounds are especially preferable. The anticorrosive content is preferably about 0.2 part to 5 parts by weight (e.g. 0.3 part to 2 parts by weight) to 100 parts by weight of the base polymer of the foam sheet.

To obtain desirable designs and optical properties, the substrate sheet (e.g. a resin sheet) may be colored black, white or other with various types of colorant (e.g. pigment) content. As a black colorant, carbon black is preferable. It is also possible to employ a method where at least one surface (one or each face) of the substrate sheet is subjected to printing to overlay one, two or more colored layers (e.g. a black layer and a white layer).

To the substrate sheet (e.g. a resin substrate sheet, a foam substrate sheet), various additives may be added as necessary, such as filler (inorganic filler, organic filler, etc.), anti-aging agent, antioxidant, UV ray absorber, antistatic agent, slip agent and plasticizer.

When the laminate sheet is adhesive on one face, between the two surfaces of the substrate sheet, the surface (back face) opposite from the surface to be provided with a PSA layer is preferably made smooth. According to the art disclosed herein, when an adhesively single-faced laminate sheet is wound to bring the back face of the substrate sheet in contact with the PSA layer surface, grooves can be formed in the adhesive surface of the laminate sheet to allow passage of air and the like without subjecting the back face to a process such as embossing. The aforementioned smooth surface may be the outer face of the laminate sheet; and therefore, when the laminate sheet having the smooth surface is used as, for instance, a decorative sheet or a surface protection sheet, it may provide a better appearance (design). In a preferable embodiment, from the standpoint of the adhesive properties and the quality of appearance (design), the back face of the substrate sheet may have an arithmetic mean surface roughness of 1 μm or less (e.g. about 0.05 μm to 0.75 μm, typically about 0.1 μm to 0.5 μm). In this description, the arithmetic mean surface roughness can be measured using a general surface roughness gauge (e.g. non-contact three-dimensional surface profilometer under model name WYKO NT-3300 available from Veeco).

When an adhesively single-faced laminate sheet is wound to bring the back face of the substrate sheet in contact with the PSA layer surface, the back face (opposite from the surface to be provided with a PSA layer) of the substrate sheet may be subjected as necessary to a release treatment with a silicone-based, long chain alkyl-based, fluorine-based release agent or the like. The release treatment brings about effects such as easier unwinding of the laminate sheet wound in a roll. On the other hand, the PSA layer-side surface of the substrate sheet may be subjected to a heretofore known surface treatment such as corona discharge treatment and primer coating for purposes such as increasing the tightness of adhesion between the substrate and the PSA layer.

The thickness of the substrate sheet is not particularly limited and can be suitably selected in accordance with the purpose. In general, the substrate thickness is suitably 1 μm or larger (e.g. about 2 μm to 500 μm), or preferably about 5 μm to 500 μm (e.g. 10 μm to 200 μm, typically 15 μm to 100 μm). It is advantageous to limit the thickness of the substrate sheet in view of making the laminate sheet thinner, smaller, lighter, resources-saving, and so on.

When the substrate sheet comprises a foam sheet, the thickness of the foam-containing substrate (e.g. a foam substrate sheet) can be suitably selected in accordance with the strength and flexibility of the laminate sheet, intended purposes and so on. From the standpoint of the impact-absorbing properties, etc., the foam-containing substrate has a thickness of suitably 30 μm or larger, preferably 50 μm or larger, or more preferably 60 μm or larger (e.g. 80 μm or larger). From the standpoint of making the laminate sheet thinner, smaller, lighter, resource-saving, and so on, the thickness of the foam-containing substrate is usually suitably 1 mm or smaller. The use of the foam sheet disclosed herein can bring about excellent impact-absorbing capabilities even when the thickness is about 350 μm or smaller (more preferably 250 μm or smaller, e.g. 180 μm or smaller). The thickness of the foam sheet (possibly a foam layer) in the foam-containing substrate can also be preferably selected from the ranges exemplified as the thickness of the aforementioned foam-containing substrate.

The PSA layer disclosed herein typically refers to a layer formed of a material (PSA) that exists as a soft solid (a viscoelastic material) in a room temperature range and has a property to adhere easily to adherend with some pressure applied. As defined in “Adhesion Fundamental and Practice” by C. A. Dahlquist (McLaren & Sons (1966), P. 143), the PSA referred to herein is generally a material that has a property satisfying complex tensile modulus E* (1 Hz)<10⁷ dyne/cm² (typically, a material that exhibits the described characteristics at 25° C.).

The PSA layer disclosed herein may be formed from a PSA composition such as aqueous, solvent-based, hot-melt and active energy ray-curable kinds. The aqueous PSA composition refers to a PSA composition that comprises PSA (PSA-forming components) in a solvent (an aqueous solvent) comprising water as the primary component, typically including a so-called water-dispersed PSA composition (a composition in an embodiment where at least some of the PSA is dispersed in water). The solvent-based PSA composition refers to a PSA composition in an embodiment comprising PSA in an organic solvent. From the standpoint of reducing environmental stress, an aqueous PSA composition is preferable. From the standpoint of the adhesive properties, etc., a solvent-based PSA composition is preferably used.

The PSA layer disclosed herein may comprise, as its base polymer, one, two or more species among acrylic polymers, rubber-based polymers, polyester-based polymers, urethane-based polymers, polyether-based polymers, silicone-based polymers, polyamide-based polymers, fluorine-based polymers, etc. From the standpoint of the adhesive properties (e.g. peel strength, repulsion resistance), molecular design, etc., acrylic polymers can be preferably used. In other words, the PSA layer is preferably an acrylic PSA layer that comprises an acrylic polymer as its base polymer. The “base polymer” of a PSA refers to the primary component (typically, a component accounting for more than 50% by weight) among polymers in the PSA.

As the acrylic polymer, for example, a polymer of a monomeric starting material comprising an alkyl (meth)acrylate as a primary monomer and possibly comprising a secondary monomer copolymerizable with the primary monomer is preferable. The primary monomer herein refers to a component that accounts for higher than 50% by weight of the monomer composition in the monomeric starting material.

As the alkyl (meth)acrylate, for instance, a compound represented by the following formula (1) can preferably be used:

CH₂═C(R¹)COOR² (1)

Herein, R¹ in the formula (1) is a hydrogen atom or a methyl group. R² is a acyclic alkyl group having 1 to 20 carbon atoms (hereinafter, such a numerical range of carbon atoms may be indicated as “C₁₋₂₀”). From the standpoint of the storage elastic modulus of the PSA, etc., an alkyl (meth)acrylate having a C₁₋₁₂ (e.g. C₂₋₁₀, typically C₄₋₈) acyclic alkyl group for R² is preferable. For the alkyl (meth)acrylate having a C₁₋₂₀ acyclic alkyl group for R², solely one species or a combination of two or more species can be used. Preferable alkyl (meth)acrylates include n-butyl acrylate and 2-ethylhexyl acrylate.

The secondary monomer copolymerizable with the alkyl (meth)acrylate as the primary monomer may be useful in introducing crosslinking points into the acrylic polymer and increasing the cohesive strength of the acrylic polymer. As the secondary monomer, one, two or more species can be used among functional group-containing monomers such as carboxy group-containing monomers, hydroxy group-containing monomers, acid anhydride group-containing monomers, amide group-containing monomers, amino group-containing monomers, and monomers having nitrogen-containing rings. The secondary monomer may also be a vinyl ester-based monomer such as vinyl acetate, an aromatic vinyl compound such as styrene, a sulfonate group-containing monomer, a phosphate group-containing monomer, etc. For instance, from the standpoint of increasing the cohesive strength, an acrylic polymer in which a carboxy group-containing monomer or a hydroxy group-containing monomer is copolymerized as the secondary monomer is preferable. Preferable examples of the carboxy group-containing monomer include acrylic acid and methacrylic acid. Preferable examples of the hydroxy group-containing monomer include 2-hydroxyethyl acrylate and 4-hydroxybutyl acrylate.

The amount of the secondary monomer is suitably 0.5% by weight of all monomers in the acrylic polymer, or preferably 1% by weight or more. The amount of the secondary monomer is suitably 30% by weight or less of all the monomers, or preferably 10% by weight or less (e.g. 5% by weight or less). When a carboxy group-containing monomer is copolymerized in the acrylic polymer, from the standpoint of combining adhesive strength and cohesive strength, the carboxy group-containing monomer content is preferably within a range of about 0.1% to 10% by weight (e.g. 0.2% to 8% by weight, typically 0.5% to 5% by weight) of all the monomers used in the synthesis of the acrylic polymer. When a hydroxy group-containing monomer is copolymerized in the acrylic polymer, from the standpoint of combining adhesive strength and cohesive strength, the hydroxy group-containing monomer content is preferably within a range of about 0.001% to 10% by weight (e.g. 0.01% to 5%, typically 0.02% to 2% by weight) of all the monomers used in the synthesis of the acrylic polymer. When a vinyl ester-based monomer such as vinyl acetate is copolymerized as the secondary monomer, the vinyl ester-based monomer content is preferably about 30% by weight or less (typically 0.01% to 30% by weight, e.g. 0.1% to 10% by weight) of all the monomers used in the synthesis of the acrylic polymer.

The method for obtaining the acrylic polymer is not particularly limited. Various polymerization methods known as procedures for the synthesis of acrylic polymer can be suitably employed, such as solution polymerization, emulsion polymerization, bulk polymerization and suspension polymerization. For instance, a desirable acrylic polymer can be obtained by dissolving or dispersing a monomer mixture in a suitable polymerization solvent (toluene, ethyl acetate, water, etc.) and carrying out polymerization using a polymerization initiator such as an azo-based polymerization initiator and a peroxide-based initiator.

From the standpoint of combining adhesive strength and cohesive strength in a well-balanced way, the acrylic polymer disclosed herein preferably has a weight average molecular weight (Mw) in a range of 10×10⁴ or higher, but 100×10⁴ or lower. An acrylic polymer whose Mw is 20×10⁴ or higher, but 70×10⁴ or lower (e.g. 30×10⁴ or higher, but 50×10⁴ or lower) may bring about better results. In this description, Mw refers to the value based on standard polystyrene obtained by GPC (gas permeation chromatography).

From the standpoint of increasing the cohesive strength, the PSA composition preferably comprises a crosslinking agent. The type of crosslinking agent is not particularly limited; one, two or more species can be suitably selected and used among heretofore known crosslinking agents. Preferable examples of the crosslinking agent include isocyanate-based crosslinking agents and epoxy-based crosslinking agents. The amount of the crosslinking agent used is not particularly limited. For instance, to 100 parts by weight of the acrylic polymer, it can be selected from a range of about 10 parts by weight or less (e.g. about 0.005 part to 10 parts by weight, preferably about 0.01 part to 5 parts by weight).

The PSA layer disclosed herein may have a composition comprising a tackifier. The tackifier is not particularly limited. Various tackifier resins can be used, such as rosin-based tackifier resin, terpene-based tackifier resin, hydrocarbon-based tackifier resin, epoxy-based tackifier resin, polyamide-based tackifier resin, elastomer-based tackifier resin, phenolic tackifier resin, and ketone-based tackifier resin. These tackifier resins can be used solely as one species or in a combination of two or more species.

The tackifier resin preferably has a softening point (temperature of softening) of about 60° C. or higher (preferably about 80° C. or higher, typically 100° C. or higher). By this, the PSA sheet can be obtained with higher adhesive strength. The upper limit of the softening point of the tackifier resin is not particularly limited; it can be about 180° C. or lower (e.g. about 140° C. or lower). The softening point of tackifier resin referred to herein is defined as the value measured by the softening point test method (ring and ball method) specified either in JIS K5902:2006 or in JIS K2207:2006.

The amount of tackifier resin can be suitably selected in accordance with the target adhesive properties (adhesive strength, etc.). For instance, by solid content, it is preferable to use a tackifier at a ratio of about 10 parts to 100 parts by weight (more preferably 20 parts to 80 parts by weight, or yet more preferably 30 parts to 60 parts by weight) relative to 100 parts by weight of the base polymer (preferably an acrylic polymer).

The PSA composition may comprise, as necessary, various additives generally known in the field of PSA compositions, such as leveling agent, crosslinking accelerator, plasticizer, softening agent, filler, anti-static agent, anti-aging agent, UV-absorbing agent, antioxidant and photo-stabilizing agent. With respect to these various additives, heretofore known species can be used by typical methods.

The PSA layer disclosed herein should be formed so that the PSA-bearing area is placed partially and so is the PSA-free area in prescribed shapes. The PSA layer is not particularly limited otherwise. The PSA layer can be partially placed by suitably employing a method of screen printing or computer-controlled drawing, scraping, extruding, etc., to form groove(s) that runs at angles that intersect the width-direction edges of the laminate sheet.

In a preferable embodiment, a scraping method is used as the method for forming the PSA layer. The scraping method allows fast and precise formation of a regular pattern with the PSA-bearing area and PSA-free area. In particular, the scraping method is carried out as follows: Over the most of the release surface of a continuously running support, a PSA composition is evenly applied by a known coating method such as gravure coating; subsequently, after partially removal with a scraper, the PSA composition is allowed to cure (typically by drying); the PSA layer thus obtained on the support is transferred to a substrate sheet surface to obtain a laminate sheet with the PSA layer partially placed over the substrate sheet surface (transfer method). Alternatively, the embodiment in which the PSA layer is partially formed on the substrate sheet surface can also be obtained, using a substrate sheet as the support in the method described above, and partially removing the PSA composition applied to the substrate sheet, and then allowing the PSA composition to cure (typically by drying). From the standpoint of precisely forming the PSA-free area, a method where the PSA layer is transferred after scraping is particularly preferable.

As the scraper, it is preferable to use a comb-like scraper having many teeth. By this, the PSA-free area can be formed in a stripe pattern over the substrate sheet surface. In a preferable embodiment, the scraper is moved back and forth at a constant rate in the direction perpendicular to the running direction of the support. By this, wavy PSA-free area can be formed on the substrate sheet surface. In other words, wavy grooves can be formed in the adhesive surface of the laminate sheet. According to this method, a desirable pattern (typically a desirable wavy pattern) can be formed by adjusting the feed speed of the support, the number of teeth of the scraper, the rate of the back-and-forth motion, etc.

The thickness of the PSA layer disclosed herein is not particularly limited; it can be suitably selected in accordance with the purpose. Usually, from the standpoint of the productivity such as the drying efficiency, adhesive properties, etc., it is suitably about 0.5 μm to 200 μm, or preferably about 2 μm to 200 μm (e.g. 5 μm to 100 μm, typically 10 μm to 50 μm). It is advantageous to limit the thickness of the PSA layer in view of making the laminate sheet thinner, smaller, lighter, resource-saving, and so on. According to the art disclosed herein, even in an embodiment having a PSA layer with a limited thickness, the groove depth is about the same as the thickness of the PSA layer, whereby good air release properties are obtained. When the art disclosed herein is implemented in an embodiment of an adhesively double-faced sheet having a PSA layer on each face of a substrate, the thicknesses of the respective PSA layers can be identical or different.

Despite of the presence of the PSA-free area, the adhesive surface of the laminate sheet having the PSA layer may exhibit a 180° peel strength of 1.5 N/20 mm or greater (e.g. 2 N/20 mm or greater, typically 3 N/20 mm or greater). Accordingly, the laminate sheet disclosed herein can exhibit at least a certain level of adhesive strength while maintaining good air release properties. The 180° peel strength is preferably 5 N/20 mm or greater (e.g. 8 N/20 mm or greater, typically 10 N/20 mm or greater). The 180° peel strength can be measured by the method described below. In particular, the laminate sheet is cut to a 20 mm wide by 100 mm long size to obtain a measurement sample; in an environment at 23° C., 50% RH, the measurement sample is press-bonded over its adhesive surface to the surface of a stainless steel plate (SUS304BA plate) with a 2 kg roller moved back and forth once. The resultant is left standing in the same environment for 30 minutes. Using a universal tensile/compression tester, based on JIS Z 0237:2000, it is then measured for peel strength (N/20 mm) at a tensile speed of 300 mm/min at a peel angle of 180°.

The laminate sheet has two or more layers including at least a substrate sheet and a PSA layer. It may have a multi-layer structure with three or more layers including another layer added and laminated.

With respect to the laminate sheet, for instance, when the surface opposite from the adhesive surface requires features such as decoration and surface protection or when it is used as a paint-substitute sheet, it is preferably configured as an adhesively single-faced laminate sheet which is adhesive only on one face. Alternatively, for instance, when it is used for purposes such as binding and fixing, it may be an adhesively double-faced laminate sheet having a PSA layer on each face of its substrate sheet.

The laminate sheet (including the PSA layer(s) and substrate, but excluding release liners) disclosed herein is not particularly limited in overall thickness. It is suitably in a range of about 2 μm to 1000 μm (e.g. 5 μm to 500 μm, favorably 10 μm to 300 μm, typically 15 μm to 100 μm). The laminate sheet with a limited overall thickness can be advantageous in making the product to which the laminate sheet is applied smaller, lighter, resource-saving, and so on.

The art disclosed herein may be implemented in an embodiment of a release liner-supported laminate sheet having a release liner that protects the adhesive surface of the laminate sheet. As the release liner, any conventional release paper or the like can be used without any particular limitations. For example, a release liner having a release layer on a surface of a liner substrate such as a resin sheet and paper; a release liner formed from a poorly-adhesive material such as a fluorine-based polymer (polytetrafluoroethylene, etc.) or a polyolefin-based resin (polyethylene, polypropylene, etc.); or the like can be used. The release layer can be formed, for instance, by subjecting the liner substrate to a surface treatment with a release agent such as a silicone-based, a long-chain alkyl-based, a fluorine-based, a molybdenum disulfide-based release agent or the like.

By the art disclosed herein, it is possible to form grooves in the adhesive surface of the laminate sheet to allow passage of air and the like, without subjecting the release liner surface to a process such as embossing. Accordingly, in a preferable embodiment, the release liner's release surface (on the side to be in contact with the adhesive surface of the laminate sheet) is formed smooth. From the standpoint of obtaining good adhesive properties, the release surface of the release liner has an arithmetic average surface roughness of 1 μm or less (e.g. about 0.05 μm to 0.75 μm, typically about 0.1 μm to 0.5 μm). The thickness (overall thickness) of the release liner is not particularly limited. From the standpoint of the ease of removal, handling properties, strength, etc., it is preferably about 10 μm to 500 μm (e.g. 15 μm to 100 μm, typically 20 μm to 40 μm).

The concept of the laminate sheet in this description includes so-called PSA sheets, PSA tapes, PSA labels and PSA film having laminate structures. As used herein, besides a typical strip-like shape, the “long piece” encompasses a shape formed with a long piece in a joined loop such as the frame shape and ring shape described later because it is formed of a long piece just with the ends of the length direction joined together. Thus, this is also included. The laminate sheet disclosed herein may be flat or in a roll.

In the embodiment, as for the PSA-free area, two or more bands separated at prescribed intervals run in wavy shapes at angles that intersect the width-direction edges of the laminate sheet, thereby forming a wavy stripe pattern; however, the art disclosed herein is not limited to this. In the same way as, for instance, lines running obliquely to the length direction, arc shapes and soon, the bands of the PSA-free area should just run at angles that intersect the width-direction edges of the laminate sheet. With this, because air and the like looking to be trapped in the adhered area can be released from the groove formed over the band of the PSA-free area in the adhesive surface, the occurrence of trapped air and the like in the adhered area can be prevented. It can also prevent the occurrence of edge peel and the like caused by a local presence of a PSA-free area near a width-direction edge of the laminate sheet, bringing about uniform adhesive properties over the entire adhesive surface of the laminate sheet.

As described above, in applying the laminate sheet disclosed herein to an adherend, the occurrence of trapped air and the like can be highly prevented at the interface with the adherend. Thus, in either application method between application by hand (manual application) and application with an automated applicator or the like (automated application), the ease of application will improve. For example, when applied by manual application, the degree of dependence on skills of individuals can be reduced, thereby bringing about advantages such as increases in efficiency and quality of the application and their stabilization. When applied by automated application, failed application with air and the like trapped in adhered areas and reapplication work can be reduced. Accordingly, either by manual application or by automated application, it is possible to bring about increases in application efficiency and quality, stabilization of the quality and so on, thereby increasing the productivity and quality of products made with the use of the laminate sheet as well. The effects of application of the art disclosed herein are significant in an embodiment of application using an automated applicator.

Between the laminate sheet and the adherend, the air trapping and the like may occur, not just during the application, but also after the application as the time passes. In typical, after the laminate sheet is applied, upon storage and use in an environment at a relatively high temperature (e.g. 35° C. or higher), etc., the air trapping and the like may occur in the adhered area, causing degradation of the appearance. For instance, such high temperature conditions are likely to be reached in factories and outdoor in summer, inside electronics, etc. Even when used for applications exposed to such high temperature environments, the art disclosed herein can prevent the occurrence of trapped air and the like in the adhered area and inhibit degradation of the appearance for a long time.

With the benefit of the features described above, the laminate sheet disclosed herein can be preferably used for application to surfaces of various articles. Accordingly, the present description provides an article having the PSA sheet disclosed herein applied thereon. In a preferable embodiment, the laminate sheet can be used as various kinds of decorative sheet and surface protection sheet, a fixing sheet for printing plates of flexographic printing and the like, a light-blocking sheet, and so on. For instance, it is preferable as a decorative sheet (typically a paint-substitute sheet) applied to vehicle exteriors, house building materials, and so on. It is also preferable for use inside electronics such as TVs as a cover sheet used to increase the smoothness of the outer face of a chassis or to cover uneven places such as of screw holes in surfaces of various parts. The use of such a cover sheet can decrease unevenness of the appearance over the covered surface and make the dimensional precision uniform. It can also be preferably used as an exterior sheet for battery packs for which the appearance is important.

Even when made thin, with the laminate sheet disclosed herein, it is possible to prevent degradation of appearance quality after its application while maintaining good adhesive properties. Thus, it can be preferably used for applications (e.g. for mobile electronics) where a thinner build and a lighter weight are required desirably with saving of resources. In particular, it can be preferably used for purposes such as the surface protection sheet for mobile electronics (e.g. mobile phones, smartphones, tablet computers, notebook computers, etc.), binding and fixing of liquid crystal displays in the mobile electronics, fixing protection panels (lenses) to protect the displays of the mobile electronics, and fastening key module parts of mobile phones. When used for the mobile electronics, the laminate sheet may have a shape in accordance with the purpose and so on, such as a frame shape and a strip shape. In this description, to be “mobile,” it is not sufficient that it can be just carried, but it needs to be mobile enough for an individual (an average adult) to be able to carry it by hand relatively easily.

Several Examples related to the present invention are described below, but the present invention is not intended to be limited to these Examples. In the description below, “parts” and “%” are by weight unless otherwise noted.

### Foam Sheet Fabrication Example 1

With a disperser (product name ROBOMIX available from Primix Corporation), were stirred, mixed and foamed 100 parts of an aqueous dispersion (55% solid content) containing an emulsion-polymerized acrylic copolymer of ethyl acrylate, n-butyl acrylate and acrylonitrile copolymerized at a ratio of 45:48:7; 1 part of a silicone-based compound (dimethyl silicone oil, number average molecular weight 7.16×10³, weight average molecular weight 1.71×10⁴, 100% solid content (non-volatiles)); 3 parts of a fatty acid ammonium salt surfactant (a water dispersion of ammonium stearate, 33% solid content); 2 parts of an oxazoline-based crosslinking agent (product name EPOCROS WS-500 available from Nippon Shokubai Co., Ltd. 39% solid content); and 0.8 part of a polyacrylic acid-based thickener (ethyl acrylate-acrylic acid copolymer at 20% acrylic acid (copolymerization ratio), 28.7% solid content). The foamed mixture was applied over 38 μm thick PET film subjected to release treatment on one face (product name MRF #38 available from Mitsubishi Plastics, Inc.) and allowed to dry at 70° C. for 4.5 minutes and then at 140° C. for 4.5 minutes to fabricate an acrylic resin foam sheet A. The foam sheet A has a continuous foam cell structure that is 100 μm in thickness, 0.34 g/cm³ in apparent density, 65.7% in foam fraction, 72.5 μm in maximum foam cell diameter, 28.5 μm in minimum foam cell diameter, and 45 μm in average foam cell diameter. Its air permeability is at most 30 sec/100 mL.

### Foam Sheet Fabrication Example 2

With a double shaft kneader (available from Japan Steel Works, Ltd.), at 200° C., were kneaded 45 parts of polypropylene (melt flow rate (MFR) 0.35 g/10 min), 55 parts of a mixture of polyolefin-based elastomer and softener (paraffin-based extender oil), 10 parts of magnesium hydroxide, 10 parts of carbon (product name ASAHI #35 available from Asahi Carbon Co., Ltd.), 1 part of glyceryl stearate and 1.5 parts of lauric acid bis-amide (bis-lauramide). The kneaded mixture was extruded in a strand, cooled with water and then molded into pellets. The pellets were placed in a single shaft extruder (available from Japan Steel Works, Ltd.). In an atmosphere at 220° C., CO₂ gas was injected at 13 MPa (12 MPa after injected) to 5.6% of the total amount of the pellets. After sufficient saturation with CO₂ gas followed by cooling to a temperature suited for foaming, the mixture was extruded into a cylindrical shape from a die and the cylindrical foam was cut into a line along a radial direction and spread out as a sheet to obtain a long piece of raw foam sheet. The raw foam sheet was 55 μm in average foam cell diameter and 0.041 g/cm³ in apparent density. As for the polyolefinic elastomer/softener mixture, 30 parts of a softener mixed with 100 parts of a polyolefinic elastomer was used. The mixture was 6 g/10 min in MFR (230° C.) and 79° in JIS A hardness.

The resulting raw foam sheet was processed, using a continuous slicing machine used in Examples in Japanese Patent Application Publication No. 2013-100459 and a continuous processing machine having a heating roller (induction heating roller) with gap adjustment capabilities. In particular, the raw foam sheet was cut by a slitting process to a prescribed width. Using a continuous slicing machine, a layer with a low degree of foaming was sliced off from each face. The sheet was passed through the continuous processing machine set at an induction heating roller temperature of 160° C. with a 0.20 mm gap to thermally melt one face and was subjected to a slit processing. The resultant was wound at a rate of 20 m/min to obtain a roll. Subsequently, the roll was unwound and passed through the continuous processing machine set at an induction heating roller temperature of 160° C. with a 0.10 mm gap, whereby the other face which had not been melted was thermally melted and subjected to a slit processing. The resultant was wound to fabricate a polypropylene-based (PP-based) resin foam sheet B with a thermally treated face on each face. The foam sheet B has a continuous foam cell structure that is 100 μm in thickness, 0.12 g/cm³ in apparent density, 88% in foam fraction, 90 μm in maximum foam cell diameter, 30 μm in minimum foam cell diameter, and 60 μm in average foam cell diameter. Its air permeability is 133 sec/100 mL.

### [Average Foam Cell Diameter of Foam Sheet]

The average foam cell diameters of the foam sheets were determined by the following method. In particular, using a low-vacuum scanning electron microscope (product name S-3400N scanning electron microscope, available from Hitachi High-Tech Science Systems Corporation), an enlarged image of a cross section of the foam was taken and subjected to image analysis to determine the average foam cell diameter (μm). The number of foam cells analyzed was about 10 to 20. In the same manner, the smallest foam cell diameters (μm) and the largest foam cell diameters (μm) of the foam sheets were determined.

### [Density of Foam Sheet]

The foam sheets were measured for density (apparent density) based on the method described in JIS K 7222:1999. In particular, each foam sheet was punched out into a size of 100 mm by 100 mm to prepare a specimen and the dimensions of the specimen were measured. Using a 1/100 dial gauge with a 20 mm diameter measurement terminal, the thickness of the specimen was measured. From these values, the volume of the foam sheet specimen was determined. The specimen was weighed by a top-loading balance with 0.01 g readability. From these values, the apparent density (g/cm³) of the foam sheet was determined.

### [Impact Absorption of Foam Sheet]

With respect to the foam sheets A and B obtained above, test pieces cut to 20 mm by 20 mm were obtained; by employing the pendulum impact tester and the method used in Example 1 in Japanese Patent Application Publication No. 2006-47277, impact-absorbing tests were conducted at a temperature of 23° C., with a 28 g bob, at a release (swing-up) angle of 40°. The impact absorption of each foam sheet was determined by the equation below:

Impact-absorbing rate (%)={(F0−F1)/F0}×100

In the equation, F0 is the impact force exerted when only a support plate was hit with the bob; F1 is the impact force exerted when a structure formed of the support plate and the foam sheet specimen was hit on the support plate with the bob. The results are shown in Table 1. As shown Table 1, both foam sheets A and B exhibited good impact-absorbing properties.

### [Compressive Stress (Hardness) of Foam Sheet]

The foam sheets were measured for 50% compressive stress (hardness) based on JIS K 6767:1999. In particular, each of the foam sheets A and B obtained above was cut out into 100 mm by 100 mm pieces. These pieces were layered to a total thickness of at least 2 mm and the resultant was used as a measurement sample. At room temperature, using a compression tester, the measurement sample was compressed at a rate of 10 mm/min. The value (resilience in N/cm²) of the measurement sample after held at 50% compression (when compressed to 50% of its initial thickness) for 10 seconds was recorded as the 50% compressive stress. Other conditions (e.g. jig and calculation method, etc.) conformed to JIS K 6767:1999. The results are shown in Table 1.

### [Table 1]

TABLE 1

| | Foam sheet A | Foam sheet B |
|---|---|---|
| Species | Acrylic | PP-based |
| Density (g/cm³) | 0.34 | 0.12 |
| Average foam cell diameter (μm) | 45 | 60 |
| Thickness (μm) | 100 | 100 |
| Impact absorption (%) | 33 | 26 |
| 50% Compressive stress (N/cm²) | 2.3 | 1.2 |

### EXAMPLES

### Examples 1 to 3

To a reaction vessel equipped with a stirrer, thermometer, nitrogen inlet, condenser and addition funnel, were added 70 parts of n-butyl acrylate, 30 parts of 2-ethylhexyl acrylate, 3 parts of acrylic acid, 0.08 part of azobisisobutyronitrile as the polymerization initiator and toluene as the polymerization solvent. At 60° C., solution polymerization was carried out for six hours to obtain an acrylic polymer toluene solution (28 Pa·s viscosity, 40% solid content). The acrylic polymer was 44×10⁴ in Mw. To 100 parts of the acrylic polymer in the toluene solution, were admixed 30 parts of a polymerized rosin pentaerythritol ester (product name PENSEL D-125 available from Arakawa Chemical Industries, Ltd. softening point 125° C.) and 2 parts of an isocyanate-based crosslinking agent (product name CORONATE L available from Nippon Polyurethane Industry Co., Ltd.) to prepare an acrylic PSA composition.

A commercial release liner was obtained. To the release face of the release liner, the PSA composition was applied to a thickness of 2 μm after dried. By a scraping method using a comb-like scraper, the PSA layer was partially removed in a wavy stripe and allowed to dry at 100° C. for two minutes.

A PET film substrate (product name LUMIRROR available from Toray Industries, Inc.) of 2 μm thickness was obtained. To the corona-treated face of the PET substrate, the PSA layer formed on the release liner was adhered. The release liner was left as it was on the PSA layer and used to protect the surface of the PSA layer. The resulting structure was passed once through a laminator (0.3 MPa, 0.5 m/min speed) at 80° C. and allowed to age in an oven at 50° C. for one day. Laminate sheets according to the respective Examples were thus obtained, with wavy stripe patterns of PSA-free area (grooves) formed on the PET substrate surfaces as shown in FIGS. 1 and 2. Table 2 shows the groove width (mm), groove interval (PSA section width) (mm), amplitude (mm), and pitch (mm) of the pattern of the PSA-free area according to each Example.

### Examples 4 to 6

The thicknesses of the PSA layer and PET substrate were changed as shown in Table 2. Otherwise in the same manner as Example 2, laminate sheets according to the respective Examples were obtained.

### Example 7

In place of the PET film (38 μm thick) subjected to release treatment on one face, the PET film (100 μm thick) used in Example 5 was used. Otherwise, by the same method as in Fabrication Example 1, an acrylic foam layer (100 μm thick) was formed on the PET film to fabricate a laminate substrate sheet with the PET layer and foam layer. The PET layer-side surface of the substrate sheet was subjected to corona discharge treatment. In the same manner as in Example 5, to the corona-treated surface, the PSA layer was adhered to obtain a laminate sheet according to this Example.

### Example 8

As the substrate sheet, the foam sheet B was used. Otherwise in the same manner as Example 5, a laminate sheet according to this Example was obtained.

### Examples 9 to 11

No PSA-free area (grooves) were formed, but otherwise in the same manner as Examples 1, 7 and 8, laminate sheets according to Examples 9, 10 and 11 were obtained, respectively.

### [To-SUS 180° Peel Strength]

The to-SUS 180° peel strength of the laminate sheet according to each Example was evaluated. In particular, a measurement sample was cut out to a 25 mm wide by 100 mm long size from the laminate sheet. In an environment at 23° C., 50% RH, the measurement sample was press-bonded over its adhesive surface to the surface of a stainless steel plate (SUS304BA plate) with a 2 kg roller moved back and forth once. This was left standing in the same environment for 30 minutes. Using a universal tensile/compression tester, based on JIS Z 0237:2000, the peel strength (N/25 mm) was measured at a tensile speed of 300 mm/min at a peel angle of 180°. The results are shown in Table 2.

### [Evaluation of Air Release Properties]

With respect to the laminate sheet according to each Example, air release properties were visually inspected when the sheet was applied to the flat surface of an adherend. Laminate sheets that resulted in no trapped air in the interface between the laminate sheet and the adherend were graded “Pass”; Examples with the presence of trapped air observed in the adhered area were graded “Fail.” With respect to the Examples graded “Pass” in the visual inspection, the air-releasing speed was further graded on the following four levels. The results are shown in Table 2.

A: Fastest air release among test samples
B: Fast release of air from adhered area after application to adherend
C: Relatively slow release of air from adhered area after application to adherend
D: Air released after application to adherend, but considerably slow release

### [Table 2]

TABLE 2

| | | Ex. 1 | Ex. 2 | Ex. 3 | Ex. 4 | Ex. 5 | Ex. 6 | Ex. 7 | Ex. 8 | Ex. 9 | Ex. 10 | Ex. 11 |
|---|---|---|---|---|---|---|---|---|---|---|---|---|
| PSA layer | Thickness (μm) | 2 | 2 | 2 | 3 | 20 | 80 | 20 | 20 | 2 | 20 | 20 |
| Substrate | Type | PET | PET | PET | PET | PET | PET | PET film/ | PP | PET | PET film/ | PP |
| sheet | | film | film | film | film | film | film | Acrylic foam | foam | film | Acrylic foam | foam |
| | Thickness (μm) | 2 | 2 | 2 | 4 | 100 | 100 | 200 | 100 | 2 | 200 | 100 |
| Pattern | Groove width (mm) | 0.1 | 1.0 | 1.0 | 1.0 | 1.0 | 1.0 | 1.0 | 1.0 | — | — | — |
| | Groove interval (mm) | 40 | 40 | 40 | 40 | 40 | 40 | 40 | 40 | — | — | — |
| | Amplitude (mm) | 50 | 50 | 30 | 50 | 50 | 50 | 50 | 50 | — | — | — |
| | Pitch (mm) | 100 | 100 | 100 | 100 | 100 | 100 | 100 | 100 | — | — | — |

| | | | | | | | | | | | |
|---|---|---|---|---|---|---|---|---|---|---|---|
| Peel strength (N/25 mm) | 2.3 | 2.2 | 2.2 | 3.5 | 5.0 | 30.0 | 5.0 | 5.0 | 2.5 | 5.5 | 5.5 |
| Air release properties | Pass | Pass | Pass | Pass | Pass | Pass | Pass | Pass | Fail | Fail | Fail |
| Air release level | D | C | C | C | B | A | B | B | — | — | — |

Although specific embodiments of the present invention have been described in detail above, these are merely for illustrations and do not limit the scope of the claims. The art according to the claims includes various modifications and changes made to the specific embodiments illustrated above.

### REFERENCE SIGNS LIST

1: laminate sheet
1A: adhesive surface
10: substrate sheet
10A: surface of substrate sheet
15: PSA-bearing area
16: PSA-free area
17a, 17b, 17c, 17d, 17e: bands of PSA-bearing area
18a, 18b, 18c, 18d: bands of PSA-free area
20: PSA layer
25a, 25b, 25c, 25d, 25e: PSA sections
26a, 26b, 26c, 26d: grooves
WE1, WE2: width-direction edges (of laminate sheet)

1. A long piece of laminate sheet having an adhesive surface, the laminate sheet comprising:
a pressure-sensitive adhesive layer forming the adhesive surface; and
an air-impermeable substrate sheet supporting the pressure-sensitive adhesive layer, wherein
the substrate sheet has a surface partially provided with the pressure-sensitive adhesive layer, whereby the surface of the substrate sheet has a pressure-sensitive adhesive-bearing area and a pressure-sensitive adhesive-free area,
the pressure-sensitive adhesive-free area includes at least a strip-shaped area, and
the strip-shaped area runs at angles that intersect width-direction edges of the laminate sheet.

2. The laminate sheet according to claim 1, wherein the pressure-sensitive adhesive-bearing area include two or more areas separately placed on the surface of the substrate sheet, and
the strip-shaped area of the pressure-sensitive adhesive-free area is located between two adjacent areas among the two or more areas of the pressure-sensitive adhesive-bearing area.

3. The laminate sheet according to claim 1, wherein, on the surface of the substrate sheet, the pressure-sensitive adhesive-bearing area includes two or more strip-shaped areas and the pressure-sensitive adhesive-free area includes two or more strip-shaped areas, and the strip-shaped areas of the pressure-sensitive adhesive-bearing area and the strip-shaped areas of the pressure-sensitive adhesive-free area are alternately arranged.

4. The laminate sheet according to claim 1, wherein the strip-shaped area of the pressure-sensitive adhesive-free area follows a winding course on the surface of the substrate sheet.

5. The laminate sheet according to claim 1, wherein the strip-shaped area of the pressure-sensitive adhesive-free area follows a winding course having regularly repeating curves on the surface of the substrate sheet.

6. The laminate sheet according to claim 1, wherein the strip-shaped area of the pressure-sensitive adhesive-free area runs in curves on the surface of the substrate sheet.

7. The laminate sheet according to claim 1, wherein the substrate sheet comprises a resin sheet layer.

8. The laminate sheet according to claim 1, wherein the substrate sheet has a thickness of 100 μm or smaller.

9. The laminate sheet according to claim 1, wherein the adhesive surface shows a 180° peel strength of 2 N/20 mm or greater.

10. A release liner-supported laminate sheet comprising the laminate sheet according to claim 1 and a release liner protecting the adhesive surface of the laminate sheet, wherein
the release liner has two surfaces, one of which is in contact with the adhesive surface and is formed smooth.

11. The laminate sheet according to claim 1 wherein the substrate sheet comprises a foam layer.
